(19) United States
(12) Patent Application Publication
(10) Pub. No.: US 2018/0224672 A1
(43) Pub. Date: Aug. 9, 2018

(54) ANTI-GLARE AND LIGHT EXTINCTION OPTICAL LENS

(71) Applicant: HE SUNG GLASSES CO.,LTD, New Taipei City (TW)

(72) Inventor: Nai-Ming WU, New Taipei City (TW)

(21) Appl. No.: 15/701,951

(22) Filed: Sep. 12, 2017

(30) Foreign Application Priority Data
Feb. 8, 2017 (TW) 106104177

(51) Int. Cl. G02C 7/10; G01J 1/04; G02B 7/02

(52) U.S. Cl. CPC G02C 7/104; G02C 7/108; G02B 7/02; G01J 1/0407

(57) ABSTRACT

The present invention is an anti-glare and light extinction optical lens for adjusting an incident light to an emitting light, and the wavelength of the emitting light is part of the wavelength of the incident light, the anti-glare and light extinction optical lens comprises an optical carrier and a plurality of opening holes. The optical carrier has an incident surface and an emitting surface. An accommodation space is formed between the incident surface and the emitting surface. Wherein the incident surface is at a distance from the emitting surface. A plurality of opening holes is formed in the accommodation space of the optical carrier. The plurality of opening holes forms an optical tunnel, and each of the plurality of opening holes has a hole pitch from each other. Wherein when the incident light influxes from the incident surface into the accommodation space, the light tunnel filters out a part of wavelength of the incident light and outputs the emitting light from the emitting surface.

### FIELD OF THE INVENTION

The present invention is related to the technical field of optical lens, particularly an anti-glare and light extinction optical lens formed by an optical structure.

### BACKGROUND OF THE INVENTION

A conventional optical lens although provides high optical transmittance, but the harmful light and harmless light unlimitedly enter the human's eyes. The harmful light causes blurred vision and fuzziness vision, and furthermore damages the eyes, and even the retina for permanent damage.

In light of the above, the present invention provides an anti-glare and light extinction optical lens to solve the conventional problem.

### SUMMARY OF THE INVENTION

A first objective of the present invention is to provide an anti-glare and light extinction optical lens, forming a plurality of opening holes in the optical carrier, and the plurality of opening holes forms an optical tunnel to be the optical filter purpose.

A second objective of the present invention is based on the above-mentioned anti-glare and light extinction optical lens, which adjusts the hole pitch, aperture, and hole depth of the opening hole to achieve the purpose of selectively filtering at least one of the wavelength of the incident light or receive the at least one of the wavelength of the incident light.

A third objective of the present invention is based on the above-mentioned anti-glare and light extinction optical lens, comprising a dyeing layer disposed at one side of the optical carrier to achieve the purpose of filtering the ultraviolet light, absorbing the specific wavelength or intensity.

A fourth objective of the present invention is based on the above-mentioned anti-glare and light extinction optical lens, comprising a polarizer layer with a plurality of light fences, the incident light or the emitting light outputted from the optical carrier is able to change the polarization state of the emitting light to achieve the effect of eliminating reflection or increasing color.

A fifth objective of the present invention is based on the above-mentioned anti-glare and light extinction optical lens, achieving the purpose of guiding light, combination of optical carrier and dyeing layer, and filling the opening holes by the specific refractive index of the colloid.

A sixth objective of the present invention is based on the above-mentioned anti-glare and light extinction optical lens, having an emitting surface with a concave surface which is designed to fit the curvature of user's eyeball.

A seventh objective of the present invention is based on the above-mentioned anti-glare and light extinction optical lens, further forming an anti-interference layer on the emitting surface to reduce the diffraction phenomenon of the emitting light outputted from the opening holes.

To achieve the aforementioned and other objectives, the present invention is to provide an anti-glare and light extinction optical lens, which is provided for adjusting an incident light to an emitting light, and the wavelength of the emitting light is part of the wavelength of the incident light, the anti-glare and light extinction optical lens comprising an optical carrier and a plurality of opening holes. The optical carrier has an incident surface and an emitting surface. An accommodation space is formed between the incident surface and the emitting surface. Wherein the incident surface is at a distance from the emitting surface. A plurality of opening holes forms in the accommodation space of the optical carrier. The plurality of opening holes forms an optical tunnel, and each of the plurality of opening holes has a hole pitch from each other. Wherein when the incident light influxes from the incident surface into the accommodation space, the light tunnel filters out a part of wavelength of the incident light and outputs the emitting light from the emitting surface.

Compared to the conventional skill, the present invention provides an anti-glare and light extinction optical lens to prevent the user's eyes (e.g., retina) from being damaged by the harmful wavelengths of the light. In the present invention, the lens effectively filters the above-mentioned harmful wavelengths by the microstructure which is without prejudice to the user's visual perception.

In another embodiment, the lens also combines another dyeing layer to further filter or absorb specific wavelength, and does the second optical process for the emitting light from the optical carrier.

In another embodiment, the lens further combines the polarizer layer to form a plurality of optical fences for another second optical process.

In another embodiment, the lens also combines the dyeing layer and the polarizer layer to do multi optical processes to reduce and eliminate the damage of eyes by the harmful light (e.g., ultraviolet light, infrared light, high-energy blue-ray, diffuse light).

To sum up, the present invention stops the harmful light, e.g., diffuse light, refractive light, irregular reflective light, by the structure of opening holes of the optical carrier, and enable the specific light (e.g., rectilinear light) to pass, And when the specific light outputted from the optical carrier, for example, the interference wavelength caused by the opening holes is selectively disposed by the interference layer deposited by electroplating, and also the wavelength which is not disposed by the optical carrier, interference layer or the combination by the dyeing layer. Not only the dyeing layer achieves the purpose by the reflection method, absorbing method, etc., but achieves another purpose of increasing the visual effect. Finally, it is disposed a polarizer layer to increase the value of color or to change the polarization state for clearer image.

### BRIEF DESCRIPTION OF THE DRAWINGS

FIG. 1 is a three-dimensional figure of the anti-glare and light extinction optical lens of the first embodiment of the invention.

FIG. 2 is a schematic view of the anti-glare and light extinction optical lens of the invention applied in the frame and the temple.

FIG. 3(a), FIG. 3(b), FIG. 3(c) is a schematic view of the opening holes of the FIG. 1 of the invention.

FIG. 4 is a schematic cross-sectional view of the anti-glare and light extinction optical lens of the second embodiment of the invention.

FIG. 5 is a schematic cross-sectional view of the anti-glare and light extinction optical lens of the third embodiment of the invention.

### DETAILED DESCRIPTION OF THE PREFERRED EMBODIMENTS

In order to fully comprehend the objectives, features and efficacy of the present invention, a detailed description is described by the following substantial embodiments in conjunction with the accompanying drawings. The description is as below.

The description of unit, element and component in the present invention uses “one”, “a”, or “an”. The way mentioned above is for convenience, and for general meaning of the category of the present invention. Therefore, the description should be understood as “include one”, “at least one”, and include the singular and plural forms at the same time unless obvious meaning.

The description of comprise, have, include, contain, or another similar semantics has the non-exclusive meaning. For example, an element, structure, product, or device contain multi requirements are not limited in the list of the content, but include another inherent requirement of element, structure, product or device not explicitly listed in the content. In addition, the term “or” is inclusive meaning, and not exclusive meaning.

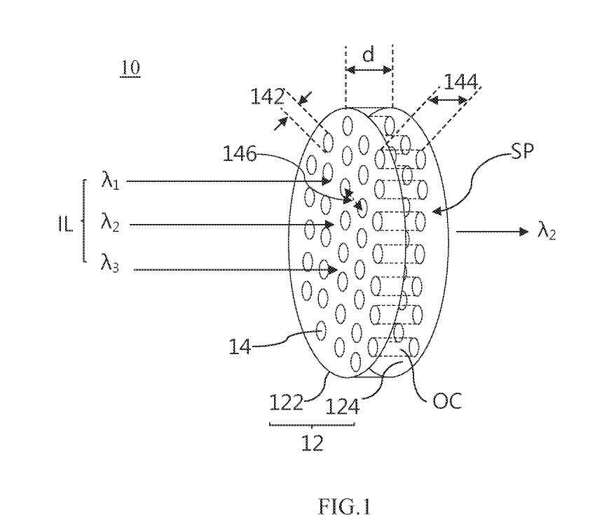

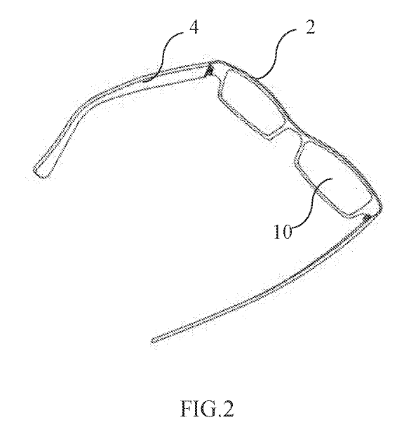

Refer to FIG. 1, which is a schematic of three-dimensional figure of an anti-glare and light extinction optical lens of the first embodiment of the present invention. In the FIG. 1, the anti-glare and light extinction optical lens 10 is able to adjust an incident light IL to an emitting light OL, and makes the wavelength λ2 of emitting IL to be part of the wavelength λ1, λ2, λ3 of the incident light. Wavelength λ1 and λ3 are assumed to be harmful to eyes e.g., the blue-ray, ultraviolet. The wavelength of incident light is illustrated by the λ1, λ2, λ3 as examples, the wavelength is not limited in 3 wavelengths in another embodiment. In addition, in order to facilitate the anti-glare and light extinction optical lens 10 in front of the user's eye, for example, using the frame 2 and the temple 4 (Ref. FIG. 2), and fixing the anti-glare and light extinction optical lens 10 on the frame 2. The example mentioned above is for illustration, in another embodiment, the anti-glare and light extinction optical lens 10 is suitable for the optical systems e.g., telescope, video camera, photo camera.

Refer to FIG. 1, the anti-glare and light extinction optical lens 10 comprises an optical carrier 12 and a plurality of opening holes 14.

Optical carrier 12 has an incident surface 122 and an emitting surface 124, refer to FIG. 2. FIG. 2 is a schematic cross-sectional view of the anti-glare and light extinction optical lens 10. An accommodation space SP is formed between the incident surface 122 and the emitting surface 124. The accommodation SP is filled with the material e.g., glass, resin. Wherein the material is able to decide the refractive index of optical carrier 12, for example, the refractive index of resin is 1.5, the refractive index of glass is 1.5˜1.9. The incident surface 122 is at a distance d from the emitting surface 124.

In the embodiment, the emitting surface 124 is a concave surface, and the concave surface has a concave to fit the curvature of user's eyeball for the purpose of reducing the refraction and the interference of light.

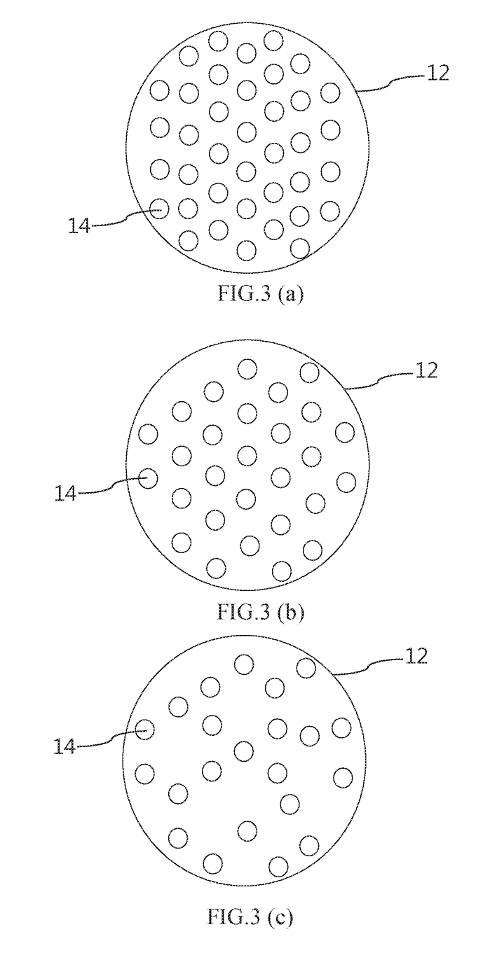

The opening holes 14 are formed in the accommodation spaces SP of the optical carrier 12. The plurality of opening holes forms a light tunnel OC. The opening holes are disposed in honeycomb, equidistance, or random arrangement. Refer to FIG. 3(a), FIG. 3(b), FIG. 3(c), wherein FIG. 3(a) is a schematic of in honeycomb, FIG. 3(b) is a schematic of in equidistance, FIG. 3(c) is a schematic of in random arrangement, The opening holes have related features, e.g., an aperture 142, a hole depth 144, and hole pitch 146, which are described as below. It is worth to note that the opening holes 14 illustrated, for example, is circle. In the present invention, the opening hole 14 is not limited to circle, the opening holes 14 is able to be any shape. The optical tunnel OC filters the intensity and wavelength of light by forming the refraction, diffusion, reflection, and diffraction.

Aperture 142 is the periphery of the opening hole 14 goes through the center of the opening holes to the periphery of the opening hole 14. For example, the shape of opening holes 14 is circle, the aperture is the diameter. Besides, in the embodiment, the size of the aperture 142 is micrometer (μm) scale. The aperture 142 has a dimensional range between 1 μm to 30 μm. Preferably, the aperture 142 is adjusted under 5 μm to increase the transmittance. And each size of the opening hole 14 can not to be constant. Preferably, specific numbers of the aperture 142 of the opening hole 14 are under 5 μm to decrease the interference of the diffusion from the incident surface IS, and increase the transmittance.

Hole depth 144 is the length from one end surface of the opening holes 14 to the other end surface. In the embodiment, the end surface is the incident surface 122 and the other end surface is the emitting surface 124, the hole depth 144 is equal to or approximately equal to the distance d. In another embodiment, the hole depth 144 is able to be less than the distance d. In addition, in the embodiment, the size of hole depth 144 is micrometer (μm) scale, The dimensional range of the hole depth 144 is between 1 μm to 20 μm.

Hole pitch 146 is the distance between the opening holes, the hole pitch 146 is the micrometer (μm) scale. In the embodiment, the distances between the opening holes 14 are the same. In another embodiment, the distances between the opening holes 14 are different depended on the actual needs and the process to adjust. The dimensional range of the hole pitch 146 is between 4 μm to 6 μm.

The emitting light OL from the emitting surface 124 could be changed by adjusting at least one of the parameter of aperture 142, hole depth 144 and hole pitch 146. In other words, the incident light IL influxes from the incident surface 122 into the accommodation space SP, the light tunnel OC filters out a part of wavelength of the incident light IL and outputs the emitting light OL from the emitting surface 124. The opening hole 14 formed in the optical carrier 12 as mentioned above is able to form a structure which is similar to the combination of lens and pin hole of the spatial filters to filter the selected wavelength.

Furthermore, in the embodiment, the opening holes 14 is able to be filled with refraction materials, e.g., glass, resin, the refraction material can be selected the same refraction index of the refraction material as the accommodation space SP.

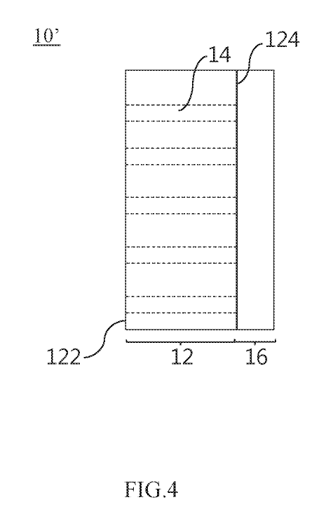

Refer to FIG. 4, which is a schematic cross-sectional view of the anti-glare and light extinction optical lens of the second embodiment of the present invention. In FIG. 4, in addition to the optical carrier 12 and the opening holes 14 of the first embodiment, the anti-glare and light extinction optical lens also has dyeing layer 16.

Dying layer 16 disposed adjacent to the emitting surface 142 adjusts the emitting light OL. The dye can be added (or dispersed) in the dyeing layer 16 to form the colored sheet. Wherein the dye can be mixed by two or more colors, and each color can be mixed by many kinds of colors. The dyeing layer 16 has the effect of the anti-ultraviolet, the specific light absorption, and stable wavelength. For example, the dye of the shades of yellowish can absorb high-energy blue-ray and reduce the damage of retina, which the range of the wavelength is between 450 nm to 500 nm. In the embodiment, according to the ratio of the dye, it can exclude, absorb, and stable the specific wavelength.

In the embodiment, it is noteworthy that in order to combine dye layer 16 and optical carrier 12, there is a colloid (no FIG.) disposed between the optical carrier 12 and dye 16. The refraction index of the colloid is selectively equal to the refraction index of the optical carrier 12 to guide at least one of the incident light IL and emitting light OL, called the light guide. Moreover, in the process of the combination of the optical carrier 12 and dyeing layer 16, the colloid fills in the opening holes 14 at the same time.

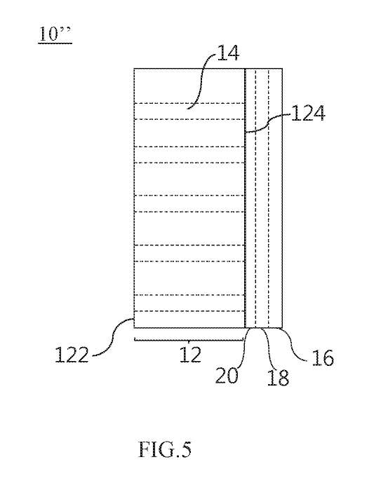

Refer to FIG. 5, which is a schematic cross-sectional view of the anti-glare and light extinction optical lens of the third embodiment of the present invention. In FIG. 5, in addition to optical carrier 12, opening hole 14, and dyeing layer 16 of the second embodiment, the anti-glare and light extinction optical lens 10″ also has polarizer layer 18 and anti-interference layer 20.

Polarizer layer 18 disposed adjacent to the optical carrier 12. In the embodiment, for example, polarizer 18 is disposed on the emitting surface OS. In another embodiment, polarizer layer 18 is also disposed on emitting surface IS. Wherein polarizer layer 18 is able to form plurality of light fences (no FIG.) which is in parallel arrangement.

Anti-interference layer 20 is formed on the emitting surface 124. Anti-interference layer 20 can amend the diffraction light from emitting light IL, the diffraction light results from opening holes 14 possibly. Diffraction layer 20 is formed by, for example, deposition.

It is noteworthy that polarizer 18, anti-interference layer 20, or both are used by the actual situation.

The present invention is disclosed by the preferred embodiment in the aforementioned description; however, it is contemplated for one skilled at the art that the embodiments are applied only for an illustration of the present invention rather than are interpreted as a limitation for the scope of the present invention. It should be noted that the various substantial alternation or replacement equivalent to these embodiments shall be considered as being covered within the scope of the present invention. Therefore, the protection scope of the present invention shall be defined by the claims.

What is claimed is:

1. An anti-glare and light extinction optical lens for adjusting an incident light to an emitting light, and the wavelength of the emitting light is part of the wavelength of the incident light, the anti-glare and light extinction optical lens comprising:
an optical carrier having an incident surface and an emitting surface, and an accommodation space forms between the incident surface and the emitting surface, wherein the incident surface is at a distance from the emitting surface; and
a plurality of opening holes forming in the accommodation space of the optical carrier, and the plurality of opening holes forms an optical tunnel, and each of the plurality of opening holes have a hole pitch from each other;
wherein when the incident light influxes from the incident surface into the accommodation space, the light tunnel filters out a part of wavelength of the incident light and outputs the emitting light from the emitting surface.

2. The anti-glare and light extinction optical lens defined in claim 1, wherein each of the opening holes having an aperture and a hole depth, and the aperture and the hole depth are micrometer (μm) scale, and the hole pitches between the opening holes are micrometer (μm) scale.

3. The anti-glare and light extinction optical lens defined in claim 2, wherein the hole pitches of each of the plurality of the opening holes are the same or different, and the opening holes are disposed in honeycomb, equidistance, or random arrangement.

4. The anti-glare and light extinction optical lens defined in claim 2, wherein the dimensional range of the aperture is between 1 μm to 30 μm, and the dimensional range of the hole depth is between 4 μm to 6 μm.

5. The anti-glare and light extinction optical lens defined in claim 2, wherein the dimensional range of the hole depth of the opening holes is between 1 μm to 20 μm.

6. The anti-glare and light extinction optical lens defined in claim 1, wherein the emitting surface having a concave surface to fit the curvature of user's eyeball.

7. The anti-glare and light extinction optical lens defined in claim 1, wherein a refraction material is filled in the opening holes, and the accommodation space is selectively filled with the refraction material.

8. The anti-glare and light extinction optical lens defined in claim 1, further comprising a dyeing layer disposed adjacent to the emitting surface for adjusting the emitting light.

9. The anti-glare and light extinction optical lens defined in claim 8, further comprising a colloid disposed between the optical carrier and the dyeing layer, and the colloid combines the optical carrier and the dyeing layer, wherein the refractive index of the colloid and the refractive index of the optical carrier are selectively the same to guide at least one of the incident light or the emitting light.

10. The anti-glare and light extinction optical lens defined in claim 1, further comprising a polarizer layer disposed adjacent to the incident surface or the emitting surface of the optical carrier, wherein the polarizer layer forms a plurality of light fences.

11. The anti-glare and light extinction optical lens defined in claim 1, further comprising an anti-interference layer formed on the emitting surface, and the anti-interference layer corrects the diffraction light from the emitting light.
